(19) United States
(12) Patent Application Publication
(10) Pub. No.: US 2025/0329250 A1
(43) Pub. Date: Oct. 23, 2025

(54) METHODS AND SYSTEMS TO CONVERT RAW ALARMS INTO NORMALIZED ALARMS

(71) Applicant: HONEYWELL INTERNATIONAL INC., Charlotte, NC (US)

(72) Inventors: Scott Kemp, New South Wales (AU); Jim Mathioudakis, Westleigh (AU); Gary James Fuller, North Parramatta (AU); Timothy Walsh, Warrawong (AU); Shailesh Rasane, Roseville (AU); Boon Toh, Toorak Gardens (AU); Andrew Lo, Balmain (AU); Joshua Worrill, Surry Hills (AU)

(21) Appl. No.: 18/641,524

(22) Filed: Apr. 22, 2024

(51) Int. Cl. G08B 29/00; G08B 27/00

(52) U.S. Cl. CPC G08B 29/00; G08B 27/005

(57) ABSTRACT

A method and system to convert raw alarms into normalized alarms is disclosed. The method comprises the steps of receiving, via one or more processors, at least one raw alarm corresponding to at least one asset, having one or more raw fields. Further, the method comprises mapping, via the one or more processors, each of the one or more raw fields with corresponding one or more fields of a predefined template related to the at least one asset, to generate one or more normalized fields. The method further comprises receiving, via the one or more processors, asset information corresponding to the at least one raw alarm associated with the at least one asset. Thereafter, the method comprises generating, via the one or more processors, at least one normalized alarm based at least on the generated one or more normalized fields and the asset information.

### TECHNOLOGICAL FIELD

The present invention relates to building management systems (BMS), and more particularly relates to a method and system to convert raw alarms into normalized alarms.

### BACKGROUND

A Building Management System (BMS), also known as a Building Automation System (BAS), is a computer-based control system installed in buildings to monitor and manage various mechanical and electrical systems. BMS is a network of “smart” microprocessor-based controllers designed for monitoring and managing building's technical systems and services, including air conditioning, ventilation, lighting, and hydraulics. Typically, the BMS is used in commercial, industrial, and institutional buildings. One of the primary function of the BMS is to monitor and control building systems such as heating, ventilation, air conditioning (HVAC), lighting, power, security, fire alarms, and other environmental and safety systems. The BMS collects data from sensors such as temperature sensors, motion detectors, and energy meters throughout the building. The data is analyzed to optimize building performance, improve energy efficiency, and identify areas for improvement.

Based on the analysis, the BMS can detect abnormalities and faults in the building systems. Further, based on inputs received from the building's technical systems and services, the BMS generates multiple alarms. The alarms generated by the BMS are linked to specific points in the building's technical systems and services, for example temperature sensors or pressure valves. However, a limitation of the multiple alarms is a lack of visibility into a broader context of how these alarms are interconnected and affects larger and critical components within the building's technical systems and services. Such lack of visibility into the broader context hampers the ability of facility managers to proactively address underlying issues before the issues escalate. Without a clear understanding of how various alarms are interconnected, the facility managers may experience inefficiencies, downtime, and increased maintenance costs.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method is disclosed. The method comprises receiving, via one or more processors, at least one raw alarm corresponding to at least one asset. Each of the at least one raw alarm having one or more raw fields. Further, the method comprises mapping, via the one or more processors, each of the one or more raw fields with corresponding one or more fields of a predefined template related to the at least one asset, to generate one or more normalized fields. Further, the method comprises receiving, via the one or more processors, asset information corresponding to the at least one raw alarm associated with the at least one asset. Thereafter, the method comprises generating, via the one or more processors, at least one normalized alarm based at least on the generated one or more normalized fields and the asset information.

In some embodiments, the one or more processors are configured to receive the at least one raw alarm from a monitoring area. The monitoring area corresponds to at least one of a building, a warehouse, a storage unit, or an office space. In some embodiments, the one or more raw fields comprises at least one of a point address, a technical address, a condition, an issue, a trip value, and an alarm value corresponding to the monitoring area.

In some embodiments, the one or more fields of the predefined template related to the at least one asset comprises at least a problem, a source, and a value. In some embodiments, the asset information associated with the at least one asset comprises at least one of a source, a location, a type, a unit, or a description corresponding to the monitoring area.

In some embodiments, the one or more processors are configured to augment the one or more normalized fields with the asset information to generate the at least one normalized alarm. In some embodiments, the at least one normalized alarm corresponds to a normalized alert having the augmented one or more normalized fields with the asset information.

In some embodiments, the method further comprises storing, via the one or more processors, the one or more fields of the predefined template, the asset information, and the one or more normalized fields in a memory communicatively coupled to the one or more processors.

In some embodiments, the one or more processors are configured to receive the asset information from an asset module that is communicatively coupled to the one or more processors.

In some embodiments, the one or more processors are configured to generate the at least one normalized alarm using one or more Artificial Intelligence (AI)/Machine Learning (ML) techniques.

In another example embodiment, a system is disclosed. The system comprises a memory and one or more processors communicatively coupled to the memory. The one or more processors are configured to receive at least one raw alarm corresponding to at least one asset. Each of the at least one raw alarm having one or more raw fields. The one or more processors are further configured to map each of the one or more raw fields with corresponding one or more fields of a predefined template related to the at least one asset, to generate one or more normalized fields. Further, the one or more processors are configured to receive asset information corresponding to the at least one raw alarm associated with the at least one asset. Thereafter, the one or more processors are configured to generate at least one normalized alarm based at least on the generated one or more normalized fields and the asset information.

In some embodiments, the one or more processors are configured to receive the at least one raw alarm from a monitoring area, wherein the monitoring area corresponds to at least one of a building, a warehouse, a storage unit, or an office space. In some embodiments, the one or more processors are configured to augment the one or more normalized fields with the asset information to generate the at least one normalized alarm. In some embodiments, the at least one normalized alarm corresponds to a normalized alert having the augmented one or more normalized fields with the asset information.

In another example embodiment, a non-transitory machine-readable information storage medium is disclosed. The non-transitory machine-readable information storage medium comprising one or more instructions which when executed by one or more processors for receiving at least one raw alarm corresponding to at least one asset, wherein each of the at least one raw alarm having one or more raw fields; mapping each of the one or more raw fields with corresponding one or more fields of a predefined template related to the at least one asset, to generate one or more normalized fields; receiving asset information corresponding to the at least one raw alarm associated with the at least one asset; and generating at least one normalized alarm based at least on the generated one or more normalized fields and the asset information.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRA WINGS

Having thus described certain example embodiments of the present disclosure in general terms, reference will hereinafter be made to the accompanying drawings, which are not necessarily drawn to scale, and wherein:

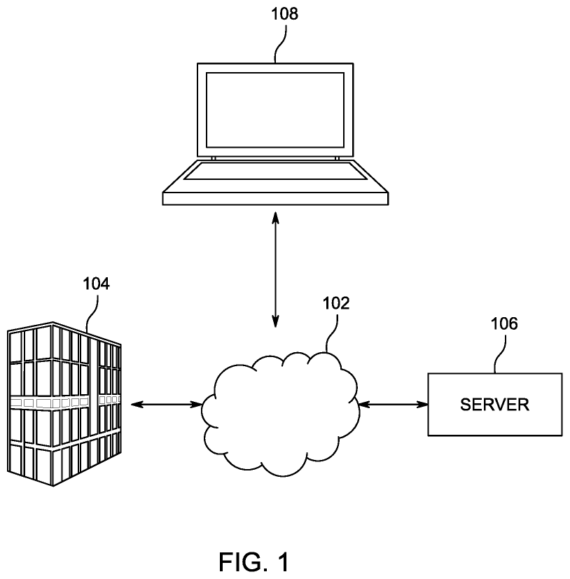

FIG. 1 illustrates a network diagram of a system for converting at least one raw alarm into at least one normalized alarm in accordance with an example embodiment of the present disclosure;

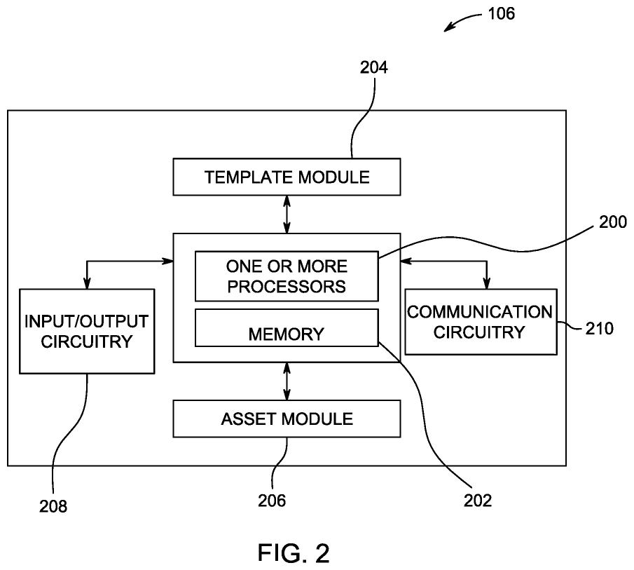

FIG. 2 illustrates a block diagram of a server for converting the at least one raw alarm into at least one normalized alarm in accordance with an example embodiment of the present disclosure;

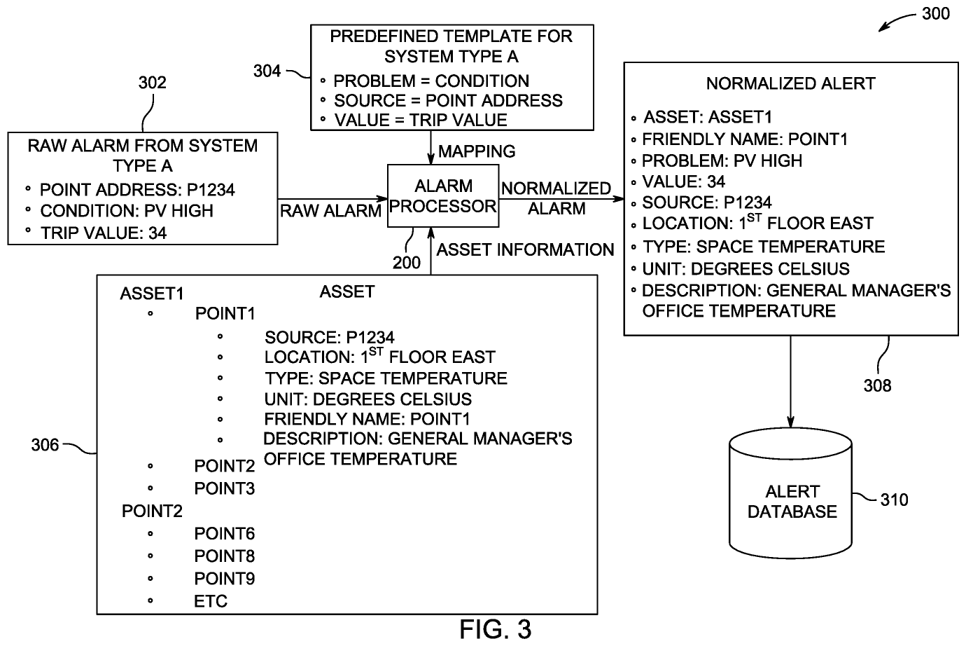

FIG. 3 illustrates a block diagram showing conversion of at least one raw alarm received from a system type A into at least one normalized alarm in accordance with an example embodiment of the present disclosure;

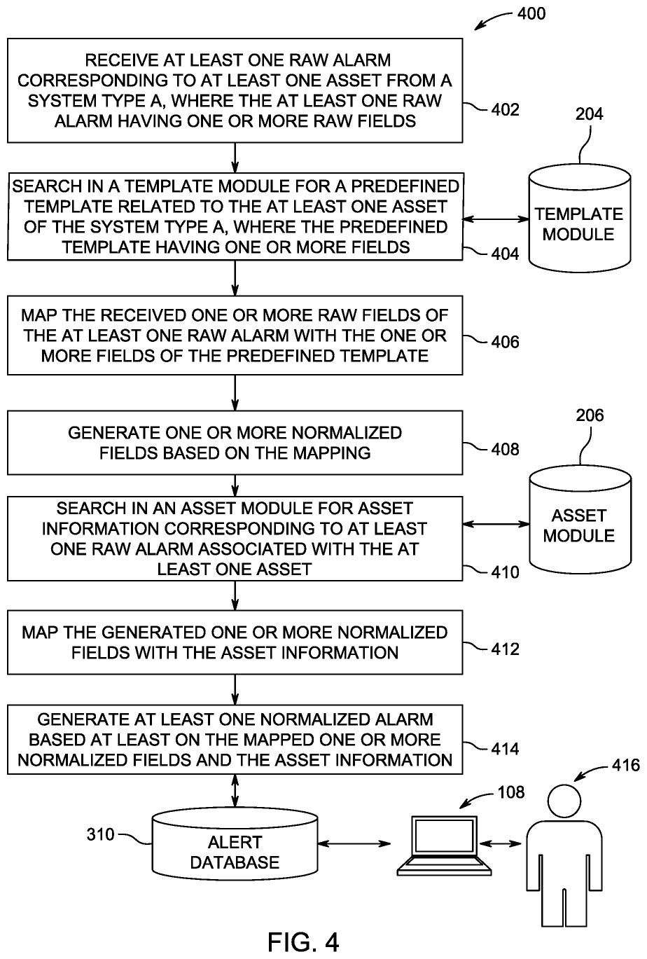

FIG. 4 illustrates a flowchart showing a method for conversion of at least one raw alarm received from the system type A into at least one normalized alarm in accordance with an example embodiment of the present disclosure;

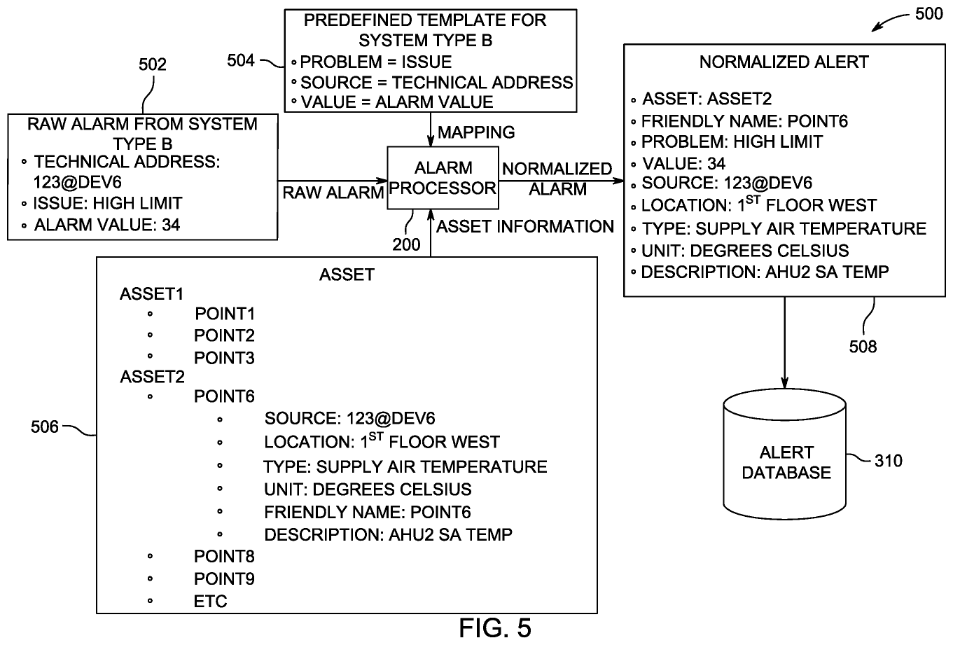

FIG. 5 illustrates a block diagram showing conversion of at least one raw alarm received from a system type B into at least one normalized alarm in accordance with an example embodiment of the present disclosure;

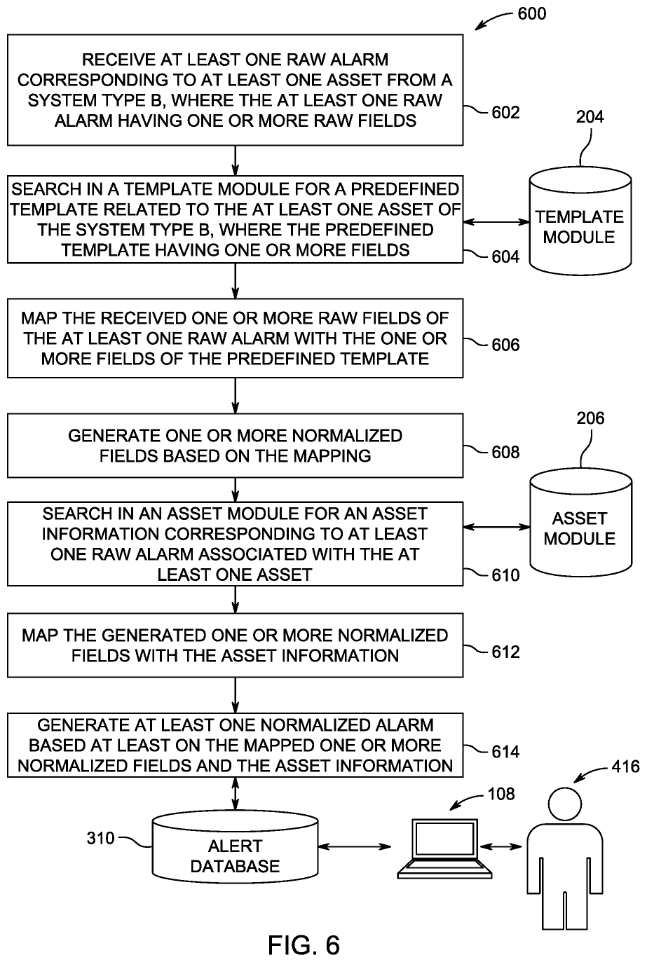

FIG. 6 illustrates a flowchart showing a method for conversion of at least one raw alarm received from the system type B into at least one normalized alarm in accordance with an example embodiment of the present disclosure; and

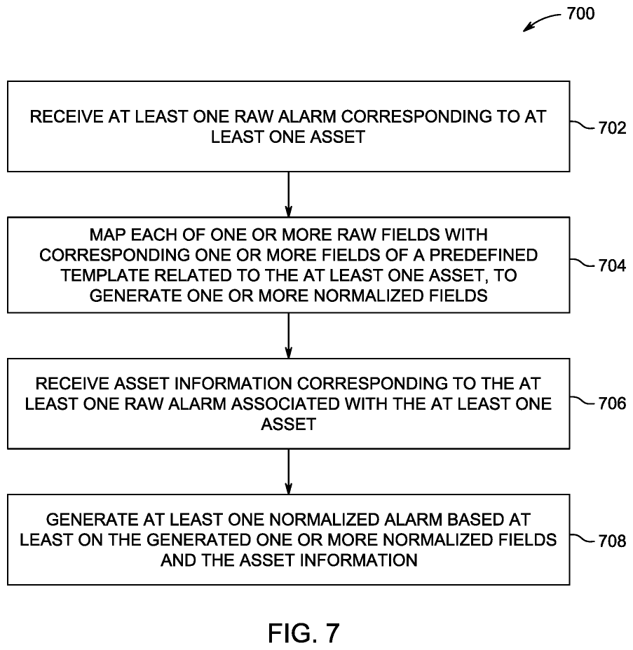

FIG. 7 illustrates a flowchart showing a method for converting at least one raw alarm into at least one normalized alarm in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems to convert at least one raw alarm into at least one normalized alarm. Embodiments may be configured to be executed by one or more processors for converting the at least one raw alarm into the at least one normalized alarm. Embodiments may be configured to utilize asset information and a predefined template for converting the at least one raw alarm into the at least one normalized alarm. Embodiments may be configured to receive the at least one raw alarm corresponding to at least one asset, originating from various monitoring areas, including buildings, warehouses, storage units, or office spaces. Embodiments may be configured to receive the at least one raw alarm having one or more raw fields. The one or more raw fields comprising a point address, a technical address, a condition, an issue, a trip value, and an alarm value corresponding to the monitoring area. Embodiments may be configured to map the one or more raw fields of the at least one raw alarm with corresponding one or more fields of the predefined template associated with the at least one asset. The one or more fields comprises at least one of a source, a location, a type, a unit, or a description corresponding to the monitoring area.

Embodiments may be configured to generate one or more normalized fields once the mapping is completed. Embodiments may be configured to receive the asset information corresponding to the at least one raw alarm. Embodiments may be configured to receive the asset information from an asset module. Embodiments may be configured to augment the one or more normalized fields with the asset information to generate the at least one normalized alarm using one or more Artificial Intelligence (AI)/Machine Learning (ML) techniques. Embodiments may be configured to generate the at least one normalized alarm that corresponds to a normalized alert having the augmented one or more normalized fields with the asset information. Embodiments may be configured to store the one or more fields of the predefined template, the asset information, and the one or more normalized fields in a memory.

FIG. 1 illustrates a network diagram of a system 100 for converting at least one raw alarm into at least one normalized alarm, in accordance with an example embodiment of the present disclosure. The network diagram may comprise a network 102 communicatively coupled to an alarm system of a building 104, a server 106, and a user device 108.

In some embodiments, the network 102 may be a communication network such as Internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

Further, the building 104 may be installed with the alarm system. In some embodiments, the alarm system installed in the building 104 may be a security and safety systems designed to detect and alert users and authorities to potential threats, emergencies, or unauthorized access. In some embodiments, the alarm system may be installed in various types of buildings, including residential homes, commercial establishments, industrial facilities, and institutional buildings. In some embodiments, the alarm system installed within the building 104 may generate individual alarms related to internal temperature of the building 104, security alarm, gas concentration alarms, and technical systems and services of the building 104, including air conditioning, ventilation, lighting, and hydraulics.

In one example embodiment, the building 104 may be a laboratory for testing chemicals. The alarm system installed within the laboratory may generate alarm at different points such as a fire and smoke alarm, a gas detection alarm, an emergency shower alarm, a biological alarm, and a security alarm. The fire and smoke alarm may be generated in case of presence of smoke, fire and elevated temperature inside the laboratory. Further, the gas detection alarm may be generated in case the gas levels inside the laboratory exceeds beyond a safe threshold limit. Further, due to the smoke and gas detection, the emergency shower alarm may be activated to alert personnel and responders to activate emergency showers or eye wash stations in case of accidents. In some embodiments, each of the generated alarm may have individual features, parameters, or multiple fields. In some embodiments, the generated alarms may be defined as raw alarms.

In some embodiments, the server 106 may be a computer or software module that is configured to provide centralized resources, data, or services to the user device 108 operated by a user. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may be configured to receive at least one raw alarm from the building 104 via the network 102. In some embodiments, the server 106 may be configured to receive the at least one raw alarm from a monitoring area within the building 104. The monitoring area may correspond to at least one of rooms, warehouse, a storage unit, or an office space. In some embodiments, the one or more raw fields may comprise at least one of a point address, a technical address, a condition, an issue, a trip value, or an alarm value corresponding to the monitoring area.

Further, the server 106 may be configured to map each of the one or more raw fields with corresponding one or more fields of a predefined template. In some embodiments, the server 106 may be pre-saved with one or more predefined templates that comprise the one or more fields. In some embodiments, each template may have multiple normalized fields. In some embodiments, each template may be associated with an asset. The asset may be an entire building, a floor, or different alarm types such as gas detection alarm or security alarms. In some embodiments, each of the template may have pre-saved normalized fields related to the assets. In some embodiments, the server 106 may firstly select at least one template that is associated to the asset that is generated with the at least one raw alarm.

In some embodiments, the server 106 may be configured to generate and save predefined templates. Further, the server 106 may be configured to map the generated predefined templates with each of the one or more raw fields. The predefined template may be related to the at least one asset. Based on the mapping, the server 106 may be configured to generate one or more normalized fields. The one or more normalized fields may correspond to the one or more raw fields of the at least one raw alarm mapped with the one or more fields of the predefined template related to the at least one asset. In some embodiments, the server 106 may further be pre-saved with one or more asset information. The asset information may correspond to technical or non-technical information associated with the at least one asset.

In some embodiments, the server 106 may be configured to generate at least one normalized alarm. The at least one normalized alarm may be generated based at least on the generated one or more normalized fields and the asset information. In some embodiments, the server 106 may be configured to augment the one or more normalized fields with the asset information, to generate the at least one normalized alarm. In some embodiments, the at least one normalized alarm may correspond to a normalized alert having the augmented one or more normalized fields with the asset information. In some embodiments, the server 106 may be configured to generate the at least one normalized alarm using one or more Artificial Intelligence (AI)/Machine Learning (ML) techniques.

In one example embodiment, the one or more AI/ML techniques may correspond to natural language processing (NLP), clustering or unsupervised learning, reinforcement learning (RL) or any other AI/ML techniques known in the art. For instance, the NLP may enable the system 100 to interpret and analyze textual data from one or more sources such as maintenance logs or sensor readings. Additionally, clustering or unsupervised learning may be employed to categorize the at least one normalized alarms based on similarity or patterns, to facilitate the identification of recurring issues or anomalies. Furthermore, the RL technique may be utilized to dynamically adjust the at least one normalized alarm thresholds or response strategies based on the at least one normalized alarm and feedback, to optimize the server 106 performance over time. The one or more AI/ML techniques may enable the server 106 to autonomously learn, adapt, and improve the at least one normalized alarm generation process, to provide actionable insights and support proactive maintenance efforts.

In some embodiments, the server 106 may further be configured to send the generated at least one normalized alarm to the user device 108. The user device 108 may be equipped by a manager of the building 10 or other service professionals responsible for addressing and reacting to the generated at least one alarm. In some embodiments, the generated at least one normalized alarm by the server 106 may provide a summarized alarm data to the user that is easy to understand and take action upon the issues inside the building 104. In some embodiments, the user device 108 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure,

FIG. 2 illustrates a block diagram of the server 106 for converting at least one raw alarm into at least one normalized alarm, in accordance with an example embodiment of the present disclosure. The server 106 may comprise one or more processors 200, a memory 202, a template module 204, an asset module 206, an input/output circuitry 208, and a communication circuitry 210.

In some embodiments, the one or more processors 200 may correspond to an alarm processor. In some embodiments, the one or more processors 200 may be configured to receive at least one raw alarm. The at least one raw alarm may correspond to at least one asset. Each of the at least one raw alarm may have one or more raw fields. In some embodiments, the one or more processors 200 may be configured to receive the at least one raw alarm from a monitoring area via a building management system (BMS) (not shown). The BMS may be a network of “smart” microprocessor-based controller designed for monitoring and managing technical instruments and services of the building 104, including air conditioning, ventilation, lighting, and hydraulics. The BMS may be configured to monitor and control building instruments such as heating, ventilation, air conditioning (HVAC), lighting, power, security, fire alarms, and other environmental and safety systems.

The BMS may be configured to collect data from sensors and devices throughout the building 104, such as temperature sensors, motion detectors, and energy meters. This data is analyzed to optimize building performance, improve energy efficiency, and identify areas for improvement. The BMS may further be configured to detect abnormalities and faults in building systems by analyzing data trends and comparing them to predefined parameters. Further, based on inputs received from the building's technical systems and services, the BMS generates multiple alarms. The alarms generated by the BMS are linked to specific points in the building's technical systems and services, for example temperature sensors or pressure valves. Further, the monitoring area may correspond to at least one of the building 104, a warehouse, a storage unit, or an office space. In some embodiments, the one or more raw fields may comprise at least one of a point address, a technical address, a condition, an issue, a trip value, or an alarm value corresponding to the monitoring area.

The one or more processors 200 may be configured to map each of the one or more raw fields with corresponding one or more fields of a predefined template. In some embodiments, the one or more fields of the predefined template related to the at least one asset may comprise at least a problem, a source, and a value. In some embodiments, the template module 204 may be configured to generate and save predefined templates. The one or more processors 200 may be configured to map the generated predefined templates with each of the one or more raw fields. The predefined template may be related to the at least one asset. Based on the mapping, the one or more processors 200 may be configured to generate one or more normalized fields. The one or more normalized fields may correspond to the one or more raw fields of the at least one raw alarm mapped with the one or more fields of the predefined template related to the at least one asset.

In some embodiments, the one or more processors 200 may be configured to receive asset information corresponding to the at least one raw alarm associated with the at least one asset from the asset module 206. In some embodiments, the asset information associated with the at least one asset may comprise at least one of a source, a location, a type, a unit, or a description corresponding to the monitoring area. In some embodiments, the one or more processors 200 may be configured to receive the asset information from the asset module 206. The asset module 206 may be communicatively coupled to the one or more processors 200.

In some embodiments, the one or more processors 200 may be configured to generate at least one normalized alarm. The at least one normalized alarm may be generated based at least on the generated one or more normalized fields and the received asset information by the one or more processors 200. In some embodiments, the one or more processors 200 may be configured to augment the one or more normalized fields with the asset information, to generate the at least one normalized alarm. In some embodiments, the at least one normalized alarm may correspond to a normalized alert having the augmented one or more normalized fields with the asset information. In some embodiments, the one or more processors 200 may be configured to generate the at least one normalized alarm using one or more Artificial Intelligence (AI)/Machine Learning (ML) techniques.

In one example embodiment, the one or more AI/ML techniques may correspond to natural language processing (NLP), clustering or unsupervised learning, reinforcement learning (RL) or any other AI/ML techniques known in the art. For instance, NLP may enable the system 100 to interpret and analyze textual data from one or more sources such as maintenance logs or sensor readings. Additionally, clustering or unsupervised learning may be employed to categorize the at least one normalized alarms based on similarity or patterns, to facilitate the identification of recurring issues or anomalies within the BMS. Furthermore, RL may be utilized to dynamically adjust the at least one normalized alarm thresholds or response strategies based on the at least one normalized alarm and feedback, to optimize the BMS performance over time. The one or more AI/ML techniques may enable the BMS to autonomously learn, adapt, and improve the at least one normalized alarm generation process, to provide actionable insights and support proactive maintenance efforts.

The one or more processors 200 may include suitable logic, circuitry, and/or interfaces that are operable to execute one or more instructions stored in the memory 202 to perform predetermined operations. In some embodiments, the one or more processors 200 may be configured to store the one or more fields of the predefined template, the asset information, and the generated one or more normalized fields in the memory 202 communicatively coupled to the one or more processors 200. In one embodiment, the one or more processors 200 may be configured to decode and execute any instructions received from one or more other electronic devices or server(s). The one or more processors 200 may be configured to execute one or more computer-readable program instructions, such as program instructions to carry out any of the functions described in this description. Further, the processor may be implemented using one or more processor technologies known in the art. Examples of the one or more processors 200 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 202 may be configured to store a set of instructions and data executed by the one or more processors 200. Further, the memory 202 may include the one or more instructions that are executable by the one or more processors 200 to perform specific operations. The memory 202 may be configured to include the instructions to receive at least one raw alarm corresponding to at least one asset, wherein each of the at least one raw alarm may comprise one or more raw fields. The memory 202 may be configured to include the instructions to map each of the one or more raw fields with corresponding one or more fields of a predefined template related to the at least one asset, to generate one or more normalized fields. Further, the memory 202 may be configured to include the instructions to receive the asset information corresponding to the at least one raw alarm associated with the at least one asset.

The memory 202 may be configured to include the instructions to generate at least one normalized alarm based at least on the generated one or more normalized fields and the asset information. It is apparent to a person with ordinary skill in the art that the one or more instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

As discussed herein, the template module 204 may be configured to generate predefined templates comprising the one or more fields associated with the at least one asset. The one or more fields may comprise information related to the at least one asset's condition or performance. In some embodiments, the one or more fields of the predefined template related to the at least one asset may comprise at least the problem, the source, and the value. In some embodiments, the problem may correspond to problem detected within the monitoring area. In some embodiments, the source may correspond to the source of the issue. In some embodiments, the value may correspond to the corresponding value of the deviation from normal operating parameters. By utilizing the predefined template, the system 100 may organize and present relevant data, to facilitate streamlined analysis and decision-making processes.

As discussed herein, the asset module 206 may be communicatively coupled to the one or more processors 200. The asset module 206 may be configured to generate asset information associated with the at least one asset. In one example embodiment, the asset module 206 may be configured to generate asset information for an “Asset 1”, or an “Asset 2” or both the “Asset 1” and the “Asset 2”. The asset information may comprise at least one of the source, the location, the type, the unit, or the description corresponding to the monitoring area. In some embodiments, the source may correspond to the source of data. In some embodiments, the location may correspond to the physical location of the at least one asset. In some embodiments, the type may correspond to the specific type. In some embodiments, the unit may correspond to the unit of measurement associated with the type. In some embodiments, the description may correspond to a descriptive label providing additional information of the at least one asset. The asset module 206 may facilitate more precise analysis, decision-making, and maintenance actions.

In some embodiments, the system 100 may further comprise the input/output circuitry 208. The input/output circuitry 208 may enable a user to communicate or interface with the system 100, via one or more user devices (not shown). The one or more user devices may include N number of user devices. In some embodiments, the input/output circuitry 208 may act as a medium to transmit input from the interface to and from the system 100. In some embodiments, the input/output circuitry 208 may refer to the hardware and software components that facilitate the exchange of information between one or more user devices and the system 100. In one example, the system 100 may include a graphical user interface (GUI) (not shown) as input circuitry to allow the one or more users to input data. The input/output circuitry 208 may include various input devices such as keyboards, barcode scanners, GUI for the one or more users to provide data and various output devices such as displays, printers for the one or more users to receive data. In another example, the input/output circuitry 208 may include various output circuitry such as a display to show the at least one normalized alarm.

In some embodiments, the system 100 may further comprise the communication circuitry 210. The communication circuitry 210 may allow the system 100 to exchange data or information with other systems or apparatuses. Further, the communication circuitry 210 may include network interfaces, protocols, and software modules responsible for sending and receiving data or information. In some embodiments, the communication circuitry 210 may include Ethernet ports, Wi-Fi adapters, or communication protocols like HTTP or MQTT for connecting with other systems. The communication circuitry 210 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 210 may allow the system 100 to stay up-to-date and accurately track the at least one normalized alerts.

In some embodiments, the input/output circuitry 208 and the communication circuitry 210 may be configured to integrate the at least one normalized alarm data with other systems such as Supervisory Control and Data Acquisition (SCADA), Building Management Systems (BMS), Enterprise Asset Management (EAM) systems, or third-party monitoring platforms for centralized monitoring, analysis, and control by operators and automated processes. It will be apparent to one skilled in the art the above-mentioned components of the system 100 have been provided only for illustration purposes, without departing from the scope of the disclosure.

FIG. 3 illustrates a block diagram 300 showing conversion of at least one raw alarm received from a system type A into at least one normalized alarm in accordance with an example embodiment of the present disclosure. FIG. 3 is described in conjunction with FIG. 2.

As discussed herein, the one or more processors 200 i.e., the alarm processor may be configured to receive at least one raw alarm corresponding to at least one asset. The at least one raw alarm may be originated from a particular asset i.e., SYSTEM TYPE A. In some example embodiment, the SYSTEM TYPE A may correspond to the building 104 as discussed in FIGS. 1 and 2. The at least one raw alarm may comprise one or more raw fields (illustrated by 302). In one example embodiment, the one or more raw fields from the SYSTEM TYPE A may include a point address “P1234”, a condition “PV HIGH”, and a trip value “34”.

Further, the one or more processors 200 may be configured to map each of the one or more raw fields with corresponding one or more fields of a predefined template (illustrated by 304) from the template module 204. In one example embodiment, the one or more fields of the predefined template may comprise a problem, a source, and a value. The predefined template may be related to the asset i.e., SYSTEM TYPE A. Further, the one or more fields of the predefined template may be mapped with the raw fields of the at least one raw alarm from SYSTEM TYPE A. In some embodiments, the problem may correspond to a condition and as a result, that may be mapped with the condition “PV HIGH” of the at least one raw alarm from SYSTEM TYPE A. Further, the source may correspond to a point address and as a result, that may be mapped with the point address “P1234” of the at least one raw alarm from SYSTEM TYPE A. Further, the value may correspond to a trip value and may be mapped with the trip value “34” of the at least one raw alarm from SYSTEM TYPE A. Therefore, the one or more processors 200 may generate one or more normalized fields, based at least on the mapping. The one or more normalized fields may comprise the problem “PV HIGH”, the source “P1234”, and the value “34”.

In some embodiments, the one or more processors 200 may be configured to receive asset information (illustrated by 306). In one example embodiment, the asset information may comprise a source “P1234”, a location “1^{st} FLOOR EAST”, a type “SPACE TEMPERATURE”, a unit “DEGRESS CELSIUS”, a friendly name “POINT 1”, a description “GENERAL MANGER'S OFFICE TEMPERATURE”, corresponding to the monitoring area. In some embodiments, the one or more processors 200 may be configured to receive the asset information from the asset module 206 communicatively coupled to the one or more processors 200 from the asset module 206.

In some embodiments, the one or more processors 200 may be configured to generate at least one normalized alarm i.e., normalized alert (illustrated by 308). The at least one normalized alarm may be generated based at least on the generated one or more normalized fields and the asset information. In some embodiments, the one or more processors 200 may be configured to augment the generated one or more normalized fields with the asset information. The one or more normalized fields may be augmented with the asset information to generate the at least one normalized alarm. In some embodiments, the one or more processors 200 may augment the problem “PV HIGH”, the source “P1234”, and the value “34” of the one or more normalized fields with the source “P1234”, the location “1^{st} FLOOR EAST”, the type “SPACE TEMPERATURE”, the unit “DEGRESS CELSIUS”, the friendly name “POINT 1”, the description “GENERAL MANGER'S OFFICE TEMPERATURE” of the asset information.

In one example embodiment, the generated at least one normalized alarm i.e., the normalized alert may comprise an asset “ASSET 1”, the friendly name “POINT 1”, the problem “PV HIGH”, the value “34”, the source “P1234”, the location “1^{st} FLOOR EAST”, the type “SPACE TEMPERATURE”, the unit “DEGRESS CELSIUS”, the description “GENERAL MANGER'S OFFICE TEMPERATURE”, corresponding to the monitoring area. In some embodiments, the at least one normalized alarm may correspond to the normalized alert having the augmented one or more normalized fields with the asset information. In some embodiments, the one or more processors 200 may be configured to generate the normalized alert using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art. Further, the at least one normalized alarm may be stored in an alert database 310 inside the memory 202.

In some embodiments, the alert database 310 may comprise structured collection of data of at least one normalized alarm that is organized, stored, and managed to enable efficient retrieval, manipulation, and querying of information. The alert database 310 may be configured to organize the data related to the at least one normalized alarm into tables, which may consist of rows and columns. In some embodiments, each row may represent a record or entity related to one or more fields associated with the at least one normalized alarm, while each column may represent a specific attribute or field of the data. This structured format may allow for efficient storage and retrieval of data based on predefined schemas. In some embodiments, the data stored within the alter database 310 may further be retrieved and assessed by the user via the user device 108 as described in FIG. 1. In some embodiments, the data related to at least one normalized alarm may be retrieve and manipulate in the alter database 310 using query languages such as SQL (Structured Query Language) or through application programming interfaces (APIs).

FIG. 4 illustrates a flowchart showing a method 400 for conversion of at least one raw alarm received from a SYSTEM TYPE A into at least one normalized alarm, in accordance with an example embodiment of the present disclosure. FIG. 4 is described in conjunction with FIG. 3.

At operation 402, the one or more processors 200 may be configured to receive the at least one raw alarm corresponding to the at least one asset from the SYSTEM TYPE A, where the at least one raw alarm having one or more raw fields. For example, the one or more processors 200 may be configured to receive at least one raw alarm corresponding to at least one asset having “Point address” as “P1234”, “Condition” as “PV High”, and “Trip value” as “34”, corresponding to the monitoring area.

In some embodiments, the one or more processors 200 i.e., the alarm processor may be configured to receive at least one raw alarm corresponding to the at least one asset. The at least one raw alarm may be originated from a particular asset i.e., SYSTEM TYPE A. In an example embodiment, the SYSTEM TYPE A may correspond to the building 104 having the alarm system as discussed in FIGS. 1-2.

At operation 404, the one or more processors 200 may be configured to search in the template module 204 for the predefined template related to the at least one asset of the system type A, where the predefined template having one or more fields. For example, the one or more processors 200 may be configured to search and retrieve the predefined template pre-coded with fields such as “Problem=Condition”, “Source=Point address”, “Value=Trip value” associated with the SYSTEM TYPE A via the template module 204. The template module 204 may be configured to generate and save the predefined templates having the one or fields related to the at least one asset. In some embodiments, the one or more fields of the predefined template may comprise a problem, a source, and a value. The predefined template may be related to the asset i.e., SYSTEM TYPE A.

At operation 406, the one or more processors 200 may be configured to map the received one or more raw fields of the at least one raw alarm with the one or more fields of the predefined template. For example, as mentioned earlier, the one or more raw fields of the at least one raw alarm may include “Point address” as “P1234”, “Condition” as “PV High”, and “Trip value” as “34”. The fields of the predefined template such as “Problem=Condition”, “Source=Point address”, “Value=Trip value” associated with the SYSTEM TYPE A. Thereafter, the one or more processors 200 may be configured to map “Point address” as “P1234” with “Source=Point address”, “Condition” as “PV High” with “Problem=Condition”, and “Trip value” as “34” with “Value=Trip value”.

At operation 408, the one or more processors 200 may be configured to generate one or more normalized fields based on the mapping of the raw fields of the at least one raw alarm with the fields of the predefined template. For example, the one or more processors 200 may be configured to generate one or more normalized fields based on the mapping initiated at the step 406. The one or more normalized fields may correspond to fields having the mapped raw fields with the fields of the predefined template related to the SYSTEM TYPE A. In some embodiments, the one or more processors 200 may be configured to store the one or more fields of the predefined template and the one or more normalized fields in the memory 202 communicatively coupled to the one or more processors 200.

At operation 410, the one or more processors 200 may be configured to search in the asset module 206 for an asset information corresponding to the at least one raw alarm associated with the at least one asset. It may be noted that the asset module 206 may be configured to generate asset information associated with each asset. The asset information may comprise at least one of the source, the location, the type, the unit, or the description corresponding to the SYSTEM TYPE A. For example, the one or more processors 200 may be configured to search and retrieve the asset information having “Source=P1234”, “Location=1^{st} floor east”, “Unit=degrees”, “Friendly name=Point 1” and “Description=General manager's office temperature”, corresponding to the at least one raw alarm associated with the SYSTEM TYPE A.

At operation 412, the one or more processors 200 may be configured to map the generated one or more normalized fields with the asset information. In some embodiments, the one or more processors 200 may be configured to augment the generated one or more normalized fields with the asset information. For example, the one or more processors 200 may be configured to map the generated one or more normalized fields with “Source=P1234”, “Location=1^{st} floor east”, “Unit=degrees”, “Friendly name=Point 1” and “Description=General manager's office temperature”.

At operation 414, the one or more processor 200 may be configured to generate at least one normalized alarm based at least on the mapped one or more normalized fields and the asset information. In some embodiments, the at least one normalized alarm may correspond to the normalized alert having the augmented one or more normalized fields with the asset information. For example, the one or more processors 200 may be configured to generate the at least one normalized alarm as “Asset=Asset 1”, “Friendly name=Point 1”, “Problem=High”, “Value=34”, “Source=P1234”, “Location=1^{st} floor”, “Type=Space temperature”, “Unit=Degrees”, Description=General manager's office temperature”.

In some embodiments, the one or more processors 200 may be configured to generate the normalized alert using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art. Further, the at least one normalized alarm may be stored in the alert database 310 inside the memory 202. Thereafter, the one or more processors 200 may display the normalized alarm to a user 416 on the user device 108 to take one or more appropriate actions.

FIG. 5 illustrates a block diagram 500 for receiving at least one raw alarm from SYSTEM TYPE B in accordance with an example embodiment of the present disclosure. FIG. 5 is described in conjunction with FIG. 2.

As discussed herein, the one or more processors 200 i.e., the alarm processor may be configured to receive at least one raw alarm corresponding to at least one asset. The at least one raw alarm may be originated from a particular asset i.e., SYSTEM TYPE B. The at least one raw alarm may comprise one or more raw fields (illustrated by 502). In one example embodiment, the one or more raw fields from the SYSTEM TYE B may include a technical address “123@DEV6”, an issue “HIGH LIMIT”, and an alarm value “34” corresponding to the monitoring area.

Further, the one or more processors 200 may be configured to map each of the one or more raw fields with corresponding one or more fields of a predefined template (illustrated by 504). In one example embodiment, the one or more fields of the predefined template may comprise a problem, a source, and a value. The predefined template may be related to the asset i.e., SYSTEM TYPE B. Further, the one or more fields of the predefined template may be mapped with the raw fields of the at least one raw alarm from SYSTEM TYPE B.

In some embodiments, the problem may correspond to an issue and as a result, is mapped with the issue “HIGH LIMIT” of the at least one raw alarm from SYSTEM TYPE B. Further, the source may correspond to a technical address and as a result, may be mapped with the technical address “123@DEV6” of the at least one raw alarm from SYSTEM TYPE B. Further, the value may correspond to an alarm value and may be mapped with the alarm value “34” of the at least one raw alarm from SYSTEM TYPE B. Therefore, the one or more processors 200 may generate one or more normalized fields, based at least on the mapping. The one or more normalized fields may comprise the problem “HIGH LIMIT”, the source “123@DEV6”, and the value “34”.

In some embodiments, the one or more processors 200 may be configured to receive asset information (illustrated by 506). In one example embodiment, the asset information may comprise a source “123@DEV6”, a location “1^{st} FLOOR WEST”, a type “SUPPLY AIR TEMPERATURE”, a unit “DEGRESS CELSIUS”, a friendly name “POINT 6”, and a description “AHU2 SA TEMP”, corresponding to the monitoring area. In some embodiments, the one or more processors 200 may be configured to receive the asset information from the asset module 206 communicatively coupled to the one or more processors 200.

In some embodiments, the one or more processors 200 may be configured to generate at least one normalized alarm i.e., normalized alert (illustrated by 508). The at least one normalized alarm may be generated based at least on the generated one or more normalized fields and the asset information. In some embodiments, the one or more processors 200 may be configured to augment the one or more normalized fields with the asset information. The one or more normalized fields may be augmented with the asset information to generate the at least one normalized alarm. In some embodiments, the one or more processors 200 may augment the problem “HIGH LIMIT”, the source “123@DEV6”, and the value “34” of the one or more normalized fields with the source “123@DEV6”, the location “1^{st} FLOOR WEST”, the type “SUPPLY AIR TEMPERATURE”, the unit “DEGRESS CELSIUS”, the friendly name “POINT 6”, and the description “AHU2 SA TEMP” of the asset information.

In one example embodiment, the generated at least one normalized alarm i.e., the normalized alert may comprise an asset “ASSET 2”, the friendly name “POINT 6”, the problem “HIGH LIMIT”, the value “34”, the source “123 @DEV6”, the location “1^{st} FLOOR WEST”, the type “SUPPLY AIR TEMPERATURE”, the unit “DEGRESS CELSIUS”, and the description “AHU2 SA TEMP”, corresponding to the monitoring area. In some embodiments, the at least one normalized alarm may correspond to the normalized alert having the augmented one or more normalized fields with the asset information. In some embodiments, the one or more processors 200 may be configured to generate the normalized alert using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art. Further, the at least one normalized alarm may be stored in an alert database 310 inside the memory 202.

It will be apparent that the components of the system 100 disclosed herein are provided only for illustrative purposes. Any modification to the current design and overall operation may be well appreciated, without departing from the scope of the disclosure.

FIG. 6 illustrates a flowchart 600 showing a method for conversion of at least one raw alarm received from the SYSTEM TYPE B into at least one normalized alarm in accordance with an example embodiment of the present disclosure. FIG. 6 is described in conjunction with FIG. 5.

At operation 602, the one or more processors 200 may be configured to receive at least one raw alarm corresponding to at least one asset from the SYSTEM TYPE B, where the at least one raw alarm having one or more raw fields. For example, the one or more processors 200 may be configured to receive at least one raw alarm corresponding to at least one asset having “Technical address” as “123@DEV6”, “Issue” as “High limit”, and “Alarm value” as “34”, corresponding to the monitoring area.

In some embodiments, the one or more processors 200 i.e., the alarm processor may be configured to receive at least one raw alarm corresponding to the at least one asset. The at least one raw alarm may be originated from a particular asset i.e., SYSTEM TYPE B. In an example embodiment, the SYSTEM TYPE B may correspond to the building 104 having the alarm system as discussed in FIGS. 1-2.

At operation 604, the one or more processors 200 may be configured to search in a template module for a predefined template related to the at least one asset of the system type B, where the predefined template having one or more fields. For example, the one or more processors 200 may be configured to search and retrieve the predefined template pre-coded with fields such as “Problem=Issue”, “Source=Technical address”, “Value=Alarm value” associated with the SYSTEM TYPE B via the template module 204. The template module 204 may be configured to generate and save the predefined templates having the one or fields related to the at least one asset. In some embodiments, the one or more fields of the predefined template may comprise a problem, a source, and a value. The predefined template may be related to the asset i.e., SYSTEM TYPE B.

At operation 606, the one or more processors 200 may be configured to map the received one or more raw fields of the at least one raw alarm with the one or more fields of the predefined template. For example, as mentioned earlier, the one or more raw fields of the at least one raw alarm may include “Technical address” as “123@DEV6”, “Issue” as “High limit”, and “Alarm value” as “34”. Thereafter, the one or more processors 200 may be configured to map “Technical address” as “123@DEV6” with “Source=Technical address”, “Issue” as “High limit” with “Problem=Issue”, and “Alarm value” as “34” with “Value=Alarm value”.

At operation 608, the one or more processors 200 may be configured to generate one or more normalized fields based on the mapping of the raw fields of the at least one raw alarm with the fields of the predefined template. For example, the one or more processors 200 may be configured to generate one or more normalized fields based on the mapping initiated at the step 606. The one or more normalized fields may correspond to fields having the mapped raw fields with the fields of the predefined template related to the SYSTEM TYPE B. In some embodiments, the one or more processors 200 may be configured to store the one or more fields of the predefined template and the one or more normalized fields in the memory 202 communicatively coupled to the one or more processors 200.

At operation 610, the one or more processors 200 may be configured to search in an asset module for an asset information corresponding to the at least one raw alarm associated with the at least one asset. It may be noted that the asset module 206 may be configured to generate asset information associated with each asset. The asset information may comprise at least one of the source, the location, the type, the unit, or the description corresponding to the SYSTEM TYPE A. For example, the one or more processors 200 may be configured to search and retrieve the asset information having “Source=123@DEV6”, “Location=1^{st} floor west”, “Type=Supply air temperature”, “Unit=degrees”, “Friendly name=Point 6” and “Description=“AHU2 SA temp”, corresponding to the at least one raw alarm associated with the SYSTEM TYPE B.

At operation 612, the one or more processors 200 may be configured to map the generated one or more normalized fields with the asset information. In some embodiments, the one or more processors 200 may be configured to augment the generated one or more normalized fields with the asset information. For example, the one or more processors 200 may be configured to map the generated one or more normalized fields with “Source=123@DEV6”, “Location=1^{st} floor west”, “Type=Supply air temperature”, “Unit=degrees”, “Friendly name=Point 6” and “Description=“AHU2 SA temp”.

At operation 614, the one or more processors 200 may be configured to generate at least one normalized alarm based at least on the mapped one or more normalized fields and the asset information. In some embodiments, the at least one normalized alarm may correspond to the normalized alert having the augmented one or more normalized fields with the asset information. For example, the one or more processors 200 may be configured to generate the at least one normalized alarm as “Asset=Asset 2”, “Friendly name=Point 6”, “Problem=High limit”, “Value=34”, “Source=123@DEV6”, “Location=1^{st} floor west”, “Type=Air supply temperature”, “Unit=Degrees Celsius”, Description=AHU2 SA temp”.

In some embodiments, the one or more processors 200 may be configured to generate the normalized alert using one or more Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art. Further, the at least one normalized alarm may be stored in the alert database 310 inside the memory 202. Thereafter, the one or more processors 200 may display the normalized alarm to a user 416 on the user device 108 to take one or more appropriate actions.

FIG. 7 illustrates a flowchart showing a method 700 for converting at least one raw alarm into at least one normalized alarm in accordance with an example embodiment of the present disclosure. FIG. 7 is described in conjunction with FIGS. 1-6.

At operation 702, the one or more processors 200 may be configured to receive at least one raw alarm corresponding to at least one asset, wherein each of the at least one raw alarm having one or more raw fields. In some embodiments, the one or more processors 200 may be configured to receive the at least one raw alarm from a monitoring area. The monitoring area may correspond to at least one of a building, a warehouse, a storage unit, or an office space. In some embodiments, the one or more raw fields may comprise at least one of a point address, a technical address, a condition, an issue, a trip value, and an alarm value corresponding to the monitoring area.

For example, at least one raw alarm is triggered in one of the production units of a large-scale manufacturing unit due to an unexpected increase in temperature, indicating a likely possible overheating issue. The at least one raw alarm, comprising one or more raw fields such as a point address “X987”, a condition “OVERHEAT”, and a trip value “235” is received by the one or more processors 200.

At operation 704, the one or more processors 200 may be configured to map each of the one or more raw fields with corresponding one or more fields of a predefined template related to the at least one asset, to generate one or more normalized fields. In some embodiments, the one or more fields of the predefined template related to the at least one asset comprises at least a problem, a source, and a value. For example, the one or more processors 200 maps each of the one or more raw fields of the at least one raw alarm with corresponding one or more fields in the predefined template, such as a problem corresponding to the condition “OVERHEAT”, a source corresponding to the point address “X987”, and a value corresponding to the trip value “235” of the at least one raw alarm, to generate one or more normalized fields the problem “OVERHEAT”, the source “X987”, and the value “235”.

At operation 706, the one or more processors 200 may be configured to receive asset information corresponding to the at least one raw alarm associated with the at least one asset. In some embodiments, the asset information associated with the at least one asset may comprise at least one of a source, a location, a type, a unit, or a description corresponding to the monitoring area. In some embodiments, the one or more processors 200 may be configured to receive the asset information from the asset module 206 communicatively coupled to the one or more processors 200. For example, the one or more processors 200 equipped with the asset module 206, receives asset information, comprising a source “X987”, a location “5^{th} FLOOR SOUTH”, a type “METAL BODY TEMPERATURE”, a unit “DEGRESS CELSIUS”, a friendly name “POINT 4”, a description “GENERATOR'S BODY TEMPERATURE”, corresponding to the monitoring area.

At operation 708, the one or more processors 200 may be configured to generate at least one normalized alarm based at least on the generated one or more normalized fields and the asset information. In some embodiments, the at least one normalized alarm may correspond to a normalized alert. In some embodiments, the one or more processors 200 may be configured to augment the one or more normalized fields with the asset information to generate the at least one normalized alarm. In some embodiments, the at least one normalized alarm may correspond to a normalized alert having the augmented one or more normalized fields with the asset information. In some embodiments, the one or more processors 200 may be configured to generate the at least one normalized alarm using one or more Artificial Intelligence (AI)/Machine Learning (ML) techniques.

For example, the one or more processors 200 augments the problem “OVERHEAT”, the source “X987”, and the value “235” of the one or more normalized fields with the source “X987”, the location “5^{th} FLOOR SOUTH”, the type “METAL BODY TEMPERATURE”, the unit “DEGRESS CELSIUS”, the friendly name “POINT 4”, and the description “GENERATOR'S BODY TEMPERATURE” of the asset information. As a result, the at least one normalized alarm comprising an asset “ASSET 6”, the friendly name “POINT 4”, the problem “OVERHEAT”, the value “235”, the source “X987”, the location “5^{th} FLOOR SOUTH”, the type “METAL BODY TEMPERATURE”, the unit “DEGRESS CELSIUS”, and the description “GENERATOR'S BODY TEMPERATURE” is generated.

In some embodiments, the method 700 may further comprise storing, via the one or more processors 200, the one or more fields of the predefined template, the asset information, and the one or more normalized fields in the memory 202 communicatively coupled to the one or more processors 200. The one or more fields of the predefined template, the asset information, and the one or more normalized fields may be stored in an alert database 310 inside the memory 202.

In some embodiments, a non-transitory machine-readable information storage medium is disclosed. The non-transitory machine-readable information storage medium may comprise one or more instructions which when executed by one or more processors 200 for receiving at least one raw alarm corresponding to at least one asset. Each of the at least one raw alarm having one or more raw fields. Further, the non-transitory machine-readable information storage medium may comprise one or more instructions which when executed by the one or more processors 200 for mapping each of the one or more raw fields with corresponding one or more fields of a predefined template related to the at least one asset, to generate one or more normalized fields. Further, the non-transitory machine-readable information storage medium may comprise one or more instructions which when executed by the one or more processors 200 for receiving asset information corresponding to the at least one raw alarm associated with the at least one asset. Thereafter, the non-transitory machine-readable information storage medium may comprise one or more instructions which when executed by the one or more processors 200 for generating at least one normalized alarm based at least on the generated one or more normalized fields and the asset information.

The present disclosure streamlines the process of identifying the root cause of problems, allowing users to take prompt action without being hindered by irrelevant or nuisance alarms. In some embodiments, the present disclosure improves the efficiency of responding to critical issues by presenting a more coherent and focused picture of the problems at hand by the normalized alarm. Further, the present disclosure focuses on a crucial process called alert normalization and enrichment that involves linking alarms generated by specific data points to broader alerts associated with larger assets. Consequently, the method and the system enables the standardization of alarms originating from different assets. The normalization process ensures that alarms, regardless of their source, can be unified into a single alert.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via one or more processors, at least one raw alarm corresponding to at least one asset, wherein each of the at least one raw alarm having one or more raw fields;
mapping, via the one or more processors, each of the one or more raw fields with corresponding one or more fields of a predefined template related to the at least one asset, to generate one or more normalized fields;
receiving, via the one or more processors, asset information corresponding to the at least one raw alarm associated with the at least one asset; and
generating, via the one or more processors, at least one normalized alarm based at least on the generated one or more normalized fields and the asset information.

2. The method of claim 1, wherein the one or more processors are configured to receive the at least one raw alarm from a monitoring area, wherein the monitoring area corresponds to at least one of a building, a warehouse, a storage unit, or an office space.

3. The method of claim 2, wherein the one or more raw fields comprises at least one of a point address, a technical address, a condition, an issue, a trip value, and an alarm value corresponding to the monitoring area.

4. The method of claim 1, wherein the one or more fields of the predefined template related to the at least one asset comprises at least a problem, a source, and a value.

5. The method of claim 2, wherein the asset information associated with the at least one asset comprises at least one of a source, a location, a type, a unit, or a description corresponding to the monitoring area.

6. The method of claim 1, wherein the one or more processors are configured to augment the one or more normalized fields with the asset information to generate the at least one normalized alarm.

7. The method of claim 6, wherein the at least one normalized alarm corresponds to a normalized alert having the augmented one or more normalized fields with the asset information.

8. The method of claim 1, further comprising
storing, via the one or more processors, the one or more fields of the predefined template, the asset information, and the one or more normalized fields in a memory communicatively coupled to the one or more processors.

9. The method of claim 1, wherein the one or more processors are configured to receive the asset information from an asset module that is communicatively coupled to the one or more processors.

10. The method of claim 1, wherein the one or more processors are configured to generate the at least one normalized alarm using one or more Artificial Intelligence (AI)/Machine Learning (ML) techniques.

11. A system comprising:
a memory; and
one or more processors communicatively coupled to the memory, wherein the one or more processors are configured to:
receive at least one raw alarm corresponding to at least one asset, wherein each of the at least one raw alarm having one or more raw fields;
map each of the one or more raw fields with corresponding one or more fields of a predefined template related to the at least one asset, to generate one or more normalized fields;
receive asset information corresponding to the at least one raw alarm associated with the at least one asset; and
generate at least one normalized alarm based at least on the generated one or more normalized fields and the asset information.

12. The system of claim 11, wherein the one or more processors are configured to receive the at least one raw alarm from a monitoring area, wherein the monitoring area corresponds to at least one of a building, a warehouse, a storage unit, or an office space.

13. The system of claim 12, wherein the one or more raw fields comprises at least a point address, a technical address, a condition, an issue, a trip value, and an alarm value corresponding to the monitoring area.

14. The system of claim 11, wherein the one or more fields of the predefined template related to the at least one asset, comprises at least a problem, a source, and a value.

15. The system of claim 12, wherein the asset information associated with the at least one asset comprises at least one of a source, a location, a type, a unit, or a description corresponding to the monitoring area.

16. The system of claim 11, wherein the one or more processors are configured to augment the one or more normalized fields with the asset information to generate the at least one normalized alarm.

17. The system of claim 16, wherein the at least one normalized alarm corresponds to a normalized alert having the augmented one or more normalized fields with the asset information.

18. The system of claim 11, wherein the one or more processors are configured to store the one or more fields of the predefined template, the asset information, and the generated one or more normalized fields in a memory communicatively coupled to the one or more processors.

19. The system of claim 11, wherein the one or more processors are configured to receive the asset information from an asset module that is communicatively coupled to the one or more processors.

20. A non-transitory machine-readable information storage medium is disclosed, the non-transitory machine-readable information storage medium comprising one or more instructions which when executed by one or more processors causes the one or more processors to perform operations comprising:
receiving, via one or more processors, at least one raw alarm corresponding to at least one asset, wherein each of the at least one raw alarm having one or more raw fields;
mapping, via the one or more processors, each of the one or more raw fields with corresponding one or more fields of a predefined template related to the at least one asset, to generate one or more normalized fields;
receiving, via the one or more processors, asset information corresponding to the at least one raw alarm associated with the at least one asset; and
generating, via the one or more processors, at least one normalized alarm based at least on the generated one or more normalized fields and the asset information.
